(19) United States
(12) Patent Application Publication
(10) Pub. No.: US 2013/0224697 A1
(43) Pub. Date: Aug. 29, 2013

(54) SYSTEMS AND METHODS FOR GENERATING DIAGNOSTIC ASSESSMENTS

(71) Applicants: Richard Douglas McCallum, San Anselmo, CA (US); Richard William Capone, Kensington, CA (US)

(72) Inventors: Richard Douglas McCallum, San Anselmo, CA (US); Richard William Capone, Kensington, CA (US)

(21) Appl. No.: 13/593,761

(22) Filed: Aug. 24, 2012

Related U.S. Application Data
(63) Continuation-in-part of application No. 12/418,019, filed on Apr. 3, 2009, now abandoned.
Application No. 12/418,019 is a continuation-in-part of application No. 11/340,873, filed on Jan. 26, 2006, now abandoned.

(51) Int. Cl. G09B 7/00; G09B 23/02; G09B 17/00

(52) U.S. Cl. CPC G09B 7/00; G09B 17/003; G09B 23/02
USPC 434/178; 434/188

(57) ABSTRACT

Systems and methods are disclosed to provide educational diagnostic assessment of reading and math performance for a student by receiving a log-in from the student over a network; presenting a new concept to the student through a multimedia presentation; testing the student on the concept at a predetermined testing level; collecting test results for one or more concepts into a test result group; performing a diagnostic analysis of the test result group; and adaptively modifying the predetermined testing level based on the adaptive diagnostic analysis and repeating the process at the modified predetermined learning level for a plurality of sub-tests.

This application is a continuation-in-part of application Ser. Nos. 12/418,019, filed on Apr. 3, 2009 and 11/340,873, filed on Jan. 26, 2006, which is also related to application Ser. No. 11/340,874, filed on Jan. 26, 2006, the contents of which are incorporated by reference.

### BACKGROUND

The present invention relates to diagnostic assessment of K-12 students and adult learners.

Today educators are increasingly being asked to evaluate and justify the actions they undertake in the process of educating students. This increase in accountability has placed new demands on educators as they seek to evaluate the effectiveness of their teaching methodology. The U.S. educational system revolves around the teaching of new concepts to students and the subsequent confirmation of the students' mastery of the concepts before advancing the students to the next stage of learning. This system relies on the validity of the tests as well as accurate assessment of the test results.

The building of a valid test begins with accurate definitions of the constructs (i.e., the knowledge domains and skills) to be assessed. If the assessment activities in a test (i.e., the test items) tap into the constructs that the test is designed to assess, then the test has construct validity. Although additional factors affect overall test validity, construct validity is the basic logical bedrock of any test.

The traditional summative outcome of an educational test is a set of test scores reflecting the numbers of correct and incorrect responses provided by each student. While such scores may provide reliable and stable information about students' standing relative to a group, they may not indicate specific patterns of skill mastery underlying students' observed item responses. Such additional information may help students and teachers better understand the meaning of test scores and the kinds of learning which might help to improve those scores.

### SUMMARY

Systems and methods are disclosed to provide educational assessment of reading and math performance for a student by receiving a log-in from the student over a network; presenting a new concept to the student through a multimedia presentation; testing the student on the concept at a predetermined learning level; collecting test results for one or more concepts test result group; performing an analysis of the test result group; and adaptively modifying the predetermined learning level based on the adaptive diagnostic assessment and repeating the process at the modified predetermined learning level for a plurality of sub-tests.

Advantages of the system may include one or more of the following. The system automates the time-consuming diagnostic assessment data collection process and provides an unbiased, consistent measurement of progress. The system provides teachers with specialist expertise and expands their knowledge and facilitates improved classroom instruction. Summative or benchmark data can be generated for existing instructional programs. Formative or diagnostic data is advantageously provided to target students' strengths and weaknesses in the fundamental sub-skills of reading and math, among others. The data paints an individual profile of each student which facilitates a unique learning path for each student. The data also tracks ongoing reading or math progress objectively over a predetermined period. The system collects diagnostic data for easy reference by teachers of each student being served and provides ongoing aggregate reporting by school or district. Detailed student reports are generated for teachers to share with parents. Teachers can see how students are doing in assessment or instruction. Day-time teachers can view student progress, even if participation is after-school, through an ESL class or Title I program, or from home. Moreover, teachers can control or modify educational track placement at any point in real-time.

Other advantages may include one or more of the following. The reading assessment the system allows the teacher to expand his or her reach to struggling readers and acts as a reading specialist when too few or none are available. The math assessment system allows the teacher to quickly diagnose the student's number computational, geometic knowledge, algebraic thinking, data analysis, and measurement skills and shows a detailed list of skills mastered by each math construct. Diagnostic data is provided to share with parents for home tutoring or with tutors or teachers for individualized instructions. All assessment reports are available at any time. Historical data is stored to track progress, and reports can be shared with tutors, teachers, or specialists. For parents, the reports can be used to tutor or teach your child yourself. The web-based system can be accessed at home or when away from home, with no complex software to install.

Other advantages and features will become apparent from the following description, including the drawings and claims.

### BRIEF DESCRIPTION OF THE DRAWINGS

Referring now to the drawings in greater detail, there is illustrated therein structure diagrams for an educational adaptive assessment system and logic flow diagrams for the processes a computer system will utilize to complete the various diagnostic assessments. It will be understood that the program is run on a computer that is capable of communication with consumers via a network, as will be more readily understood from a study of the diagrams.

FIG. 1 shows an exemplary process through which an educational adaptive diagnostic assessment is generated to assess student performance.

FIG. 2 shows details of an exemplary adaptive diagnostic engine.

FIGS. 3A-3G show exemplary reading sub-test user interfaces (UIs), while FIG. 3I shows an exemplary summary report of the tests.

FIG. 4 shows an exemplary summary table showing student performance.

FIG. 5 shows an exemplary client-server system that provides educational adaptive diagnostic assessment.

FIG. 6 shows one embodiment which provides diagnostic/formative assessment of students online.

### DESCRIPTION

FIG. 1 shows an exemplary process through which an adaptive diagnostic assessment is generated to assess student performance. The system of FIG. 1 provides tests or assessments that can provide expanded information on an individual student called formative assessments or diagnostic assessments. Diagnostic or formative assessments provide information about individual students that will guide individualized instruction.

The diagnostic assessment system of FIG. 1 can be used to provide concrete information about the student's learning progress which in turn will lead to concrete conclusions about how best to teach a particular student. This diasgnostic assessment system can determine whether test results support a valid conclusion about a student's level of skill knowledge or cognitive abilities. A diagnostic assessment can cover various aspects of reading or mathematical knowledge: skills, conceptual understanding, and problem solving. Melding together these different types of student knowledge and abilities is important in coming to understand what students know and how they approach individual cognitive tasks such as reading or performing problem solving activities. Two types of assessment essentially exist in the education field: summative assessment and formative or diagnostic assessment.

A summative assessment system is used to draw conclusions about groups of students. While specific skills may be targeted that are helpful in developing an individual student lesson plan, summative assessments do not cover enough skills to draw an accurate conclusion about individual students. This is the reason that summative assessments are NOT diagnostic. A teacher cannot concretely make individual student decisions because the information is not complete. The primary goal of a summative assessment is to take a snap shot at a particular point in time, roll the data up to the classroom, school, district, or state level, and then provide a benchmark for comparing groups of students. For example, third grade State of California Language Arts benchmark 2.5 states “Student will distinguish the main idea and supporting details in expository text.” A summative assessment might conclude that the student missed this item therefore the conclusion is to teach the student the main idea comprehension strategy. But this is a false assumption. A diagnostic assessment would see that the student missed this item but also test the student's decoding ability and grade level vocabulary. If the student was able to decode at grade level but had low vocabulary, the teacher would realize that the student does not have the ability to understand the main idea comprehension strategy because he or she cannot understand many words in the test passage. Thus, only by following up with additional measures can a teacher conclude the correct learning path for a student. This is provided by diagnostic assessment which can accurately make a conclusion on the student's learning path. If the information is too sparse then the assessment is only a summative assessment.

Turning now to FIG. 1, a student logs on-line (100). The student is presented with a new concept through a multimedia presentation including sound, image, animation, video and text (110). The student is tested for comprehension of the concept (120). An adaptive diagnostic engine presents additional questions in this concept based on the student's performance on earlier questions (130). The process is repeated for additional concepts based on the test-taker's performance on earlier concepts (140). When it is determined that additional concepts do not need to be covered for a particular test-taker, the test halts (150). Prescriptive recommendations and diagnostic test results are compiled in real-time when requested by parents or teachers by data mining the raw data and summary scores of any student's particular assessment (160).

In another implementation, a learning level initially is set to a default value or to a previously stored value. For example, the learning level can correspond to a difficulty level for the student. Based, on the currently set learning level, the student is presented with a new concept through a multimedia presentation including sound, image, animation, video and text. After the multimedia presentation, the student is tested for comprehension of the concept and the process is repeated for a predetermined number of concepts. For example, student performance is collected for every five concepts and then the results of the tests are provided to an adaptive diagnostic assessment engine. A learning level is adjusted based on the adaptive diagnostic assessment and the student is tested at the new level. Thus, the process encourages the student to learn and to be tested at new learning levels. When the battery of tests is eventually completed, the adaptive diagnostic assessment engine prints results and recommendations for users such as educators and parents.

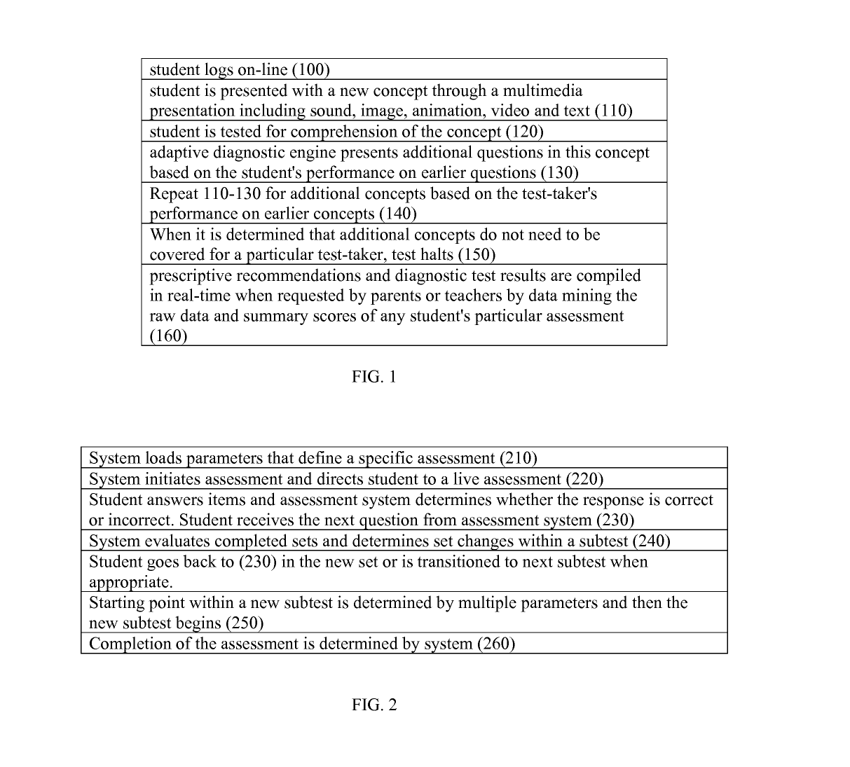

FIG. 2 shows an exemplary adaptive diagnostic assessment engine. In FIG. 2, the system loads parameters that define a specific assessment (210). The student can start the assessment or continue a previously unfinished assessment. Student's unique values determine his/her exact starting point, and based on the student's values, the system initiates assessment and directs student to a live assessment (220). The student answers items and assessment system determines whether the response is correct or incorrect and then present the next question from assessment system to the system (230). The system evaluates the completed sets and determines changes such as changes to the difficulty level by selecting a new set of questions within a subtest (240). The student goes back to (230) to continue the assessment process with a new set or is transitioned to next subtest when appropriate. A starting point within a new subtest is determined by multiple parameters and then the new subtest begins (250). The system continues testing the student until a completion of the assessment is determined by system (260).

The general application of FIG. 2 is called Online Adaptive Assessment System for Individual Students (OAASIS). The OAASIS assessment engine resides on a single or multiple application servers accessible via the web or network. OAASIS controls the logic of how students are assessed and is independent of the subject being tested. Assessments are defined to OAASIS via a series of parameters that control how adaptive decisions are made while student are taking an assessment in real-time. Furthermore, OAASIS references multiple database tables that hold the actual test times. OAASIS will pull from various tables as it reacts to answers from the test-taker. During use OAASIS can work across multiple computer processors on multiple servers. Students can perform an assessment and in real-time OAASIS will distribute its load to any available CPU.

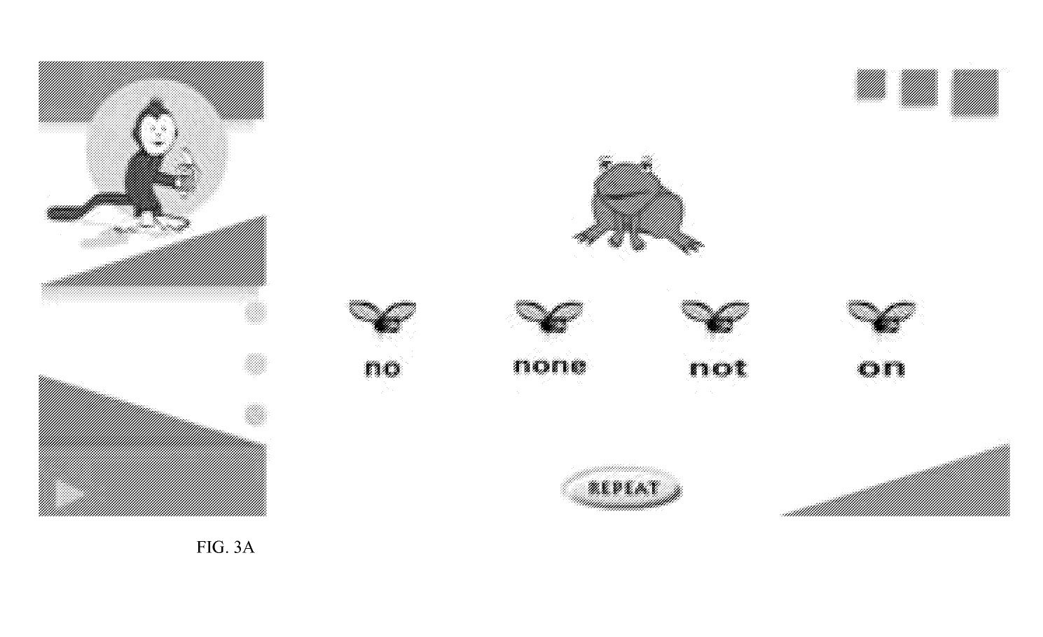

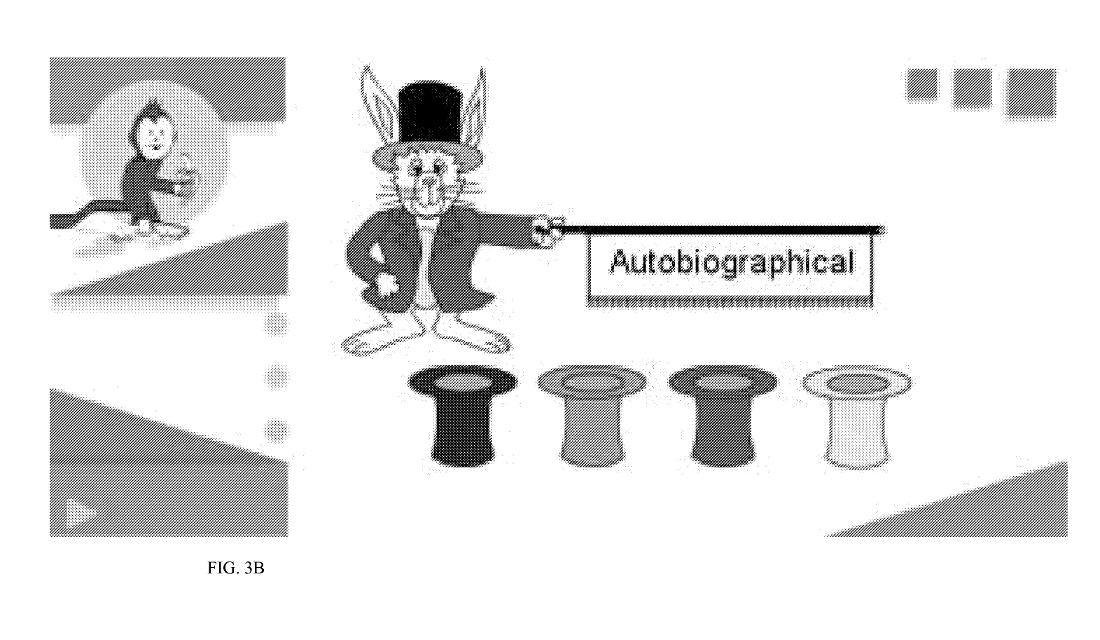

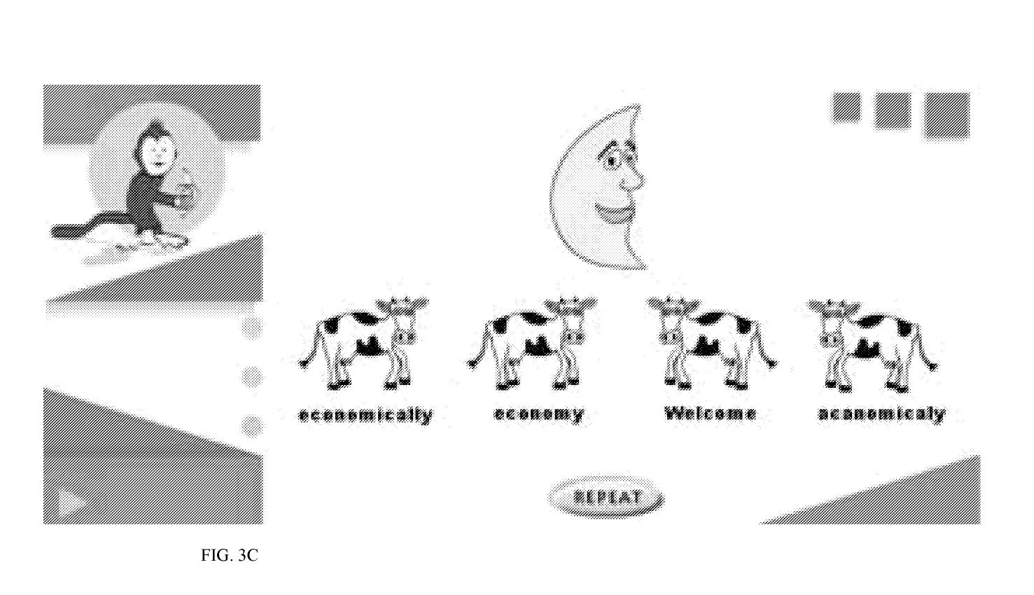

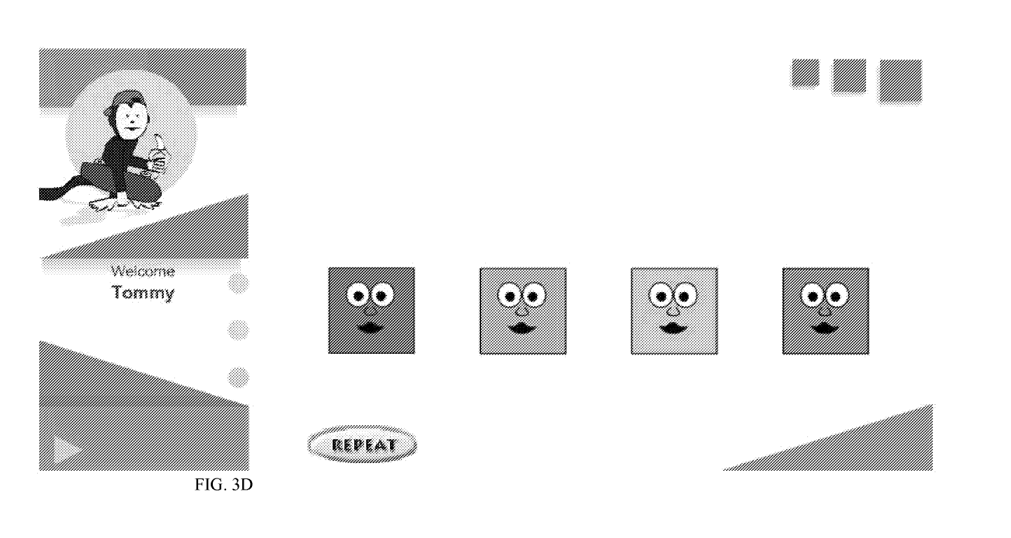

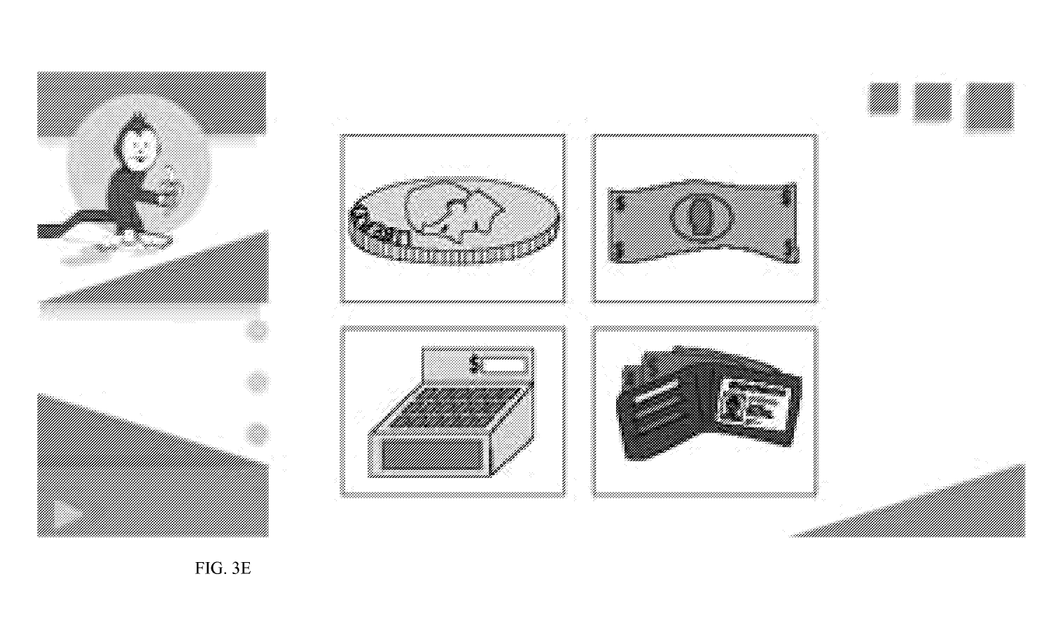

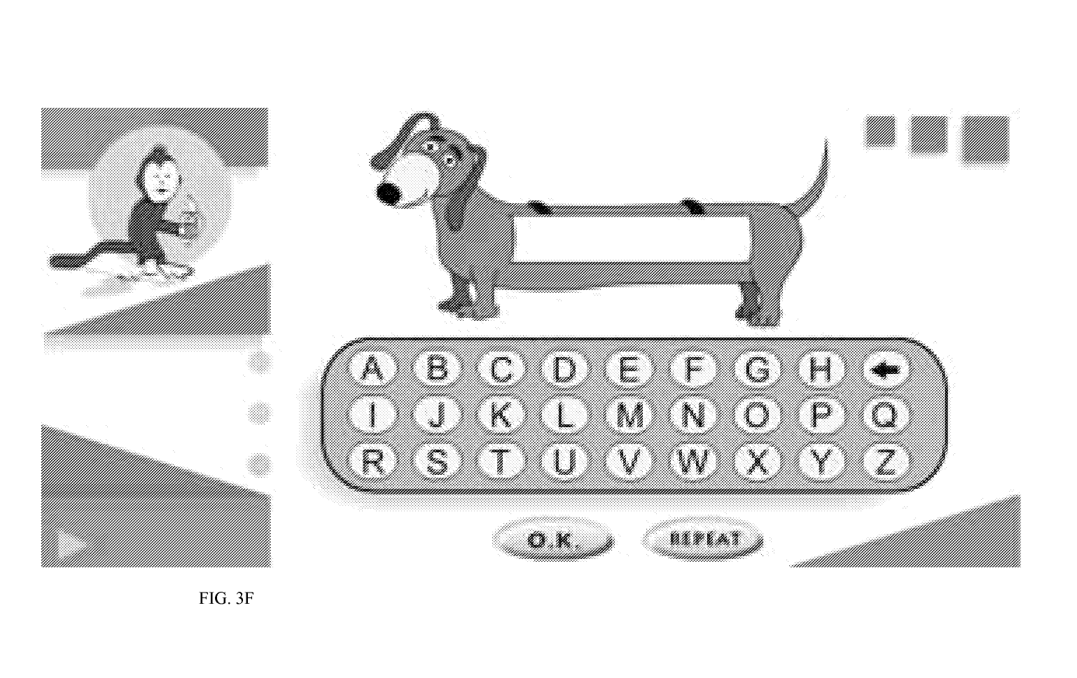

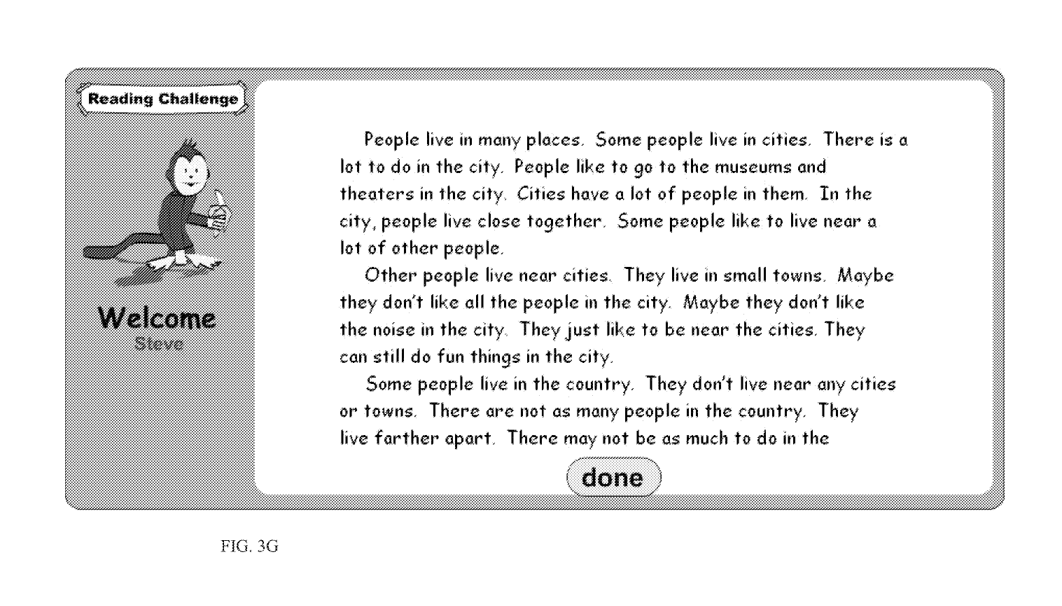

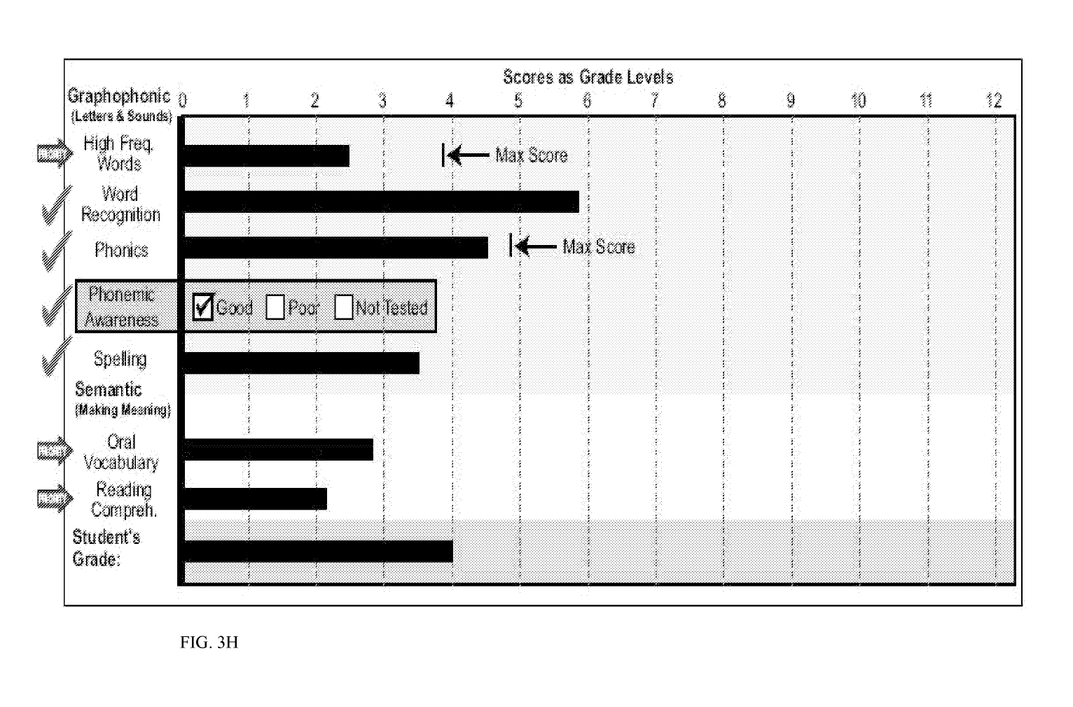

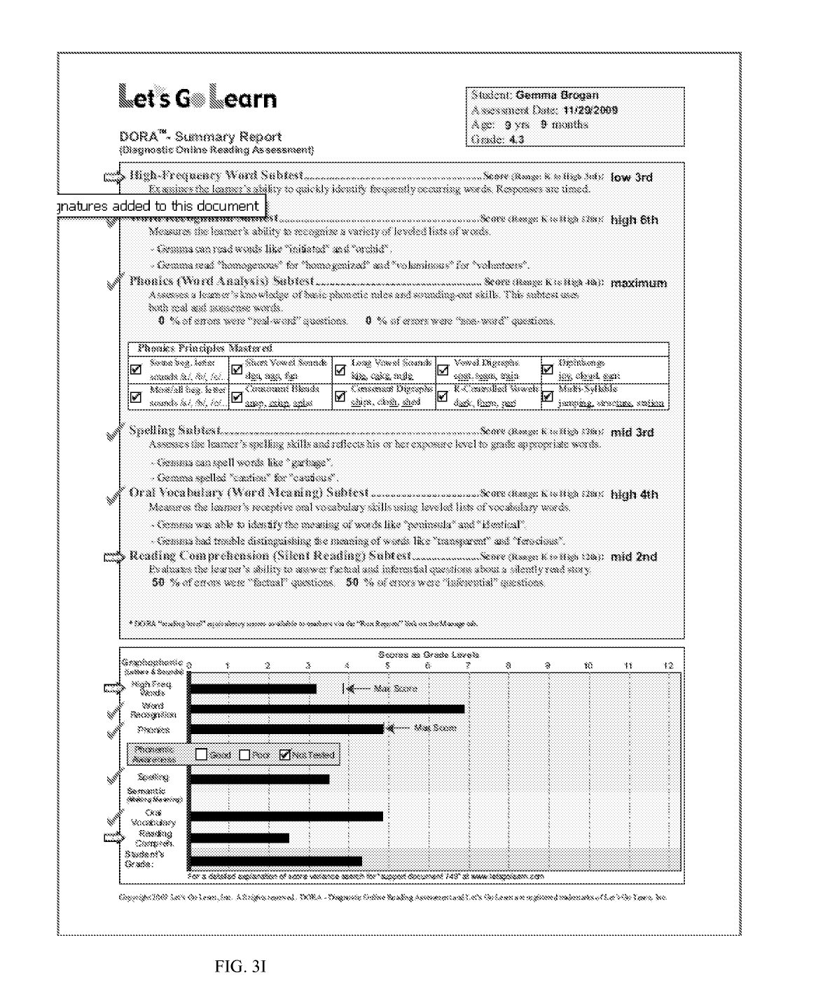

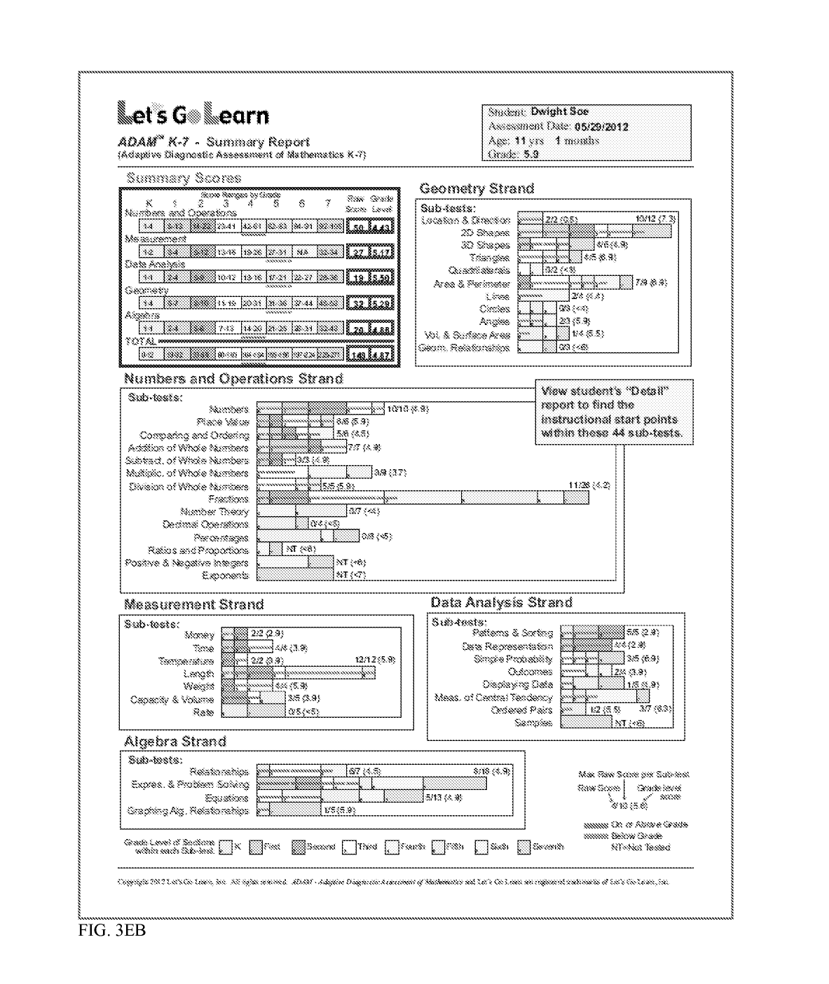

In one embodiment, the OAASIS engine of FIG. 2 is configured to perform Diagnostic Online Reading Assessment (DORA) where the system assesses students' skills in reading by looking at seven specific reading measures. Initial commencement of DORA is determined by the age, grade, or previously completed assessment of the student. Once the student begins, DORA looks at his or her responses to determine the next question to be presented, the next set, or the next subtest. The three subtests deal with the decoding abilities of a student, high-frequency words, word recognition, and phonics (or word analysis) examine at how students decode words. The performance of the student on each subtest as they are presented affects how he or she will transition to the next subtest. For example a student who performs below grade level on the first high-frequency word subtest will start at a set below his or her grade level in word recognition. The overall performance on the first three subtests as well as the student's grade level will determine whether the fourth subtest, phonemic awareness is presented or skipped. For example students who perform at third or above grade level in high-frequency word, word recognition, and phonics will skip the phonemic awareness subtest. But if the student is at the kindergarten through second grade level he or she will perform the phonemic awareness subtest regardless of his or her performance on the first three subtests. Phonemic awareness is an audio only subtest. See FIG. 3D. This means the student doesn't have to have any reading ability to respond to its questions. The next subtest is word meaning also called oral vocabulary. It measures a student's oral vocabulary. Its starting point is determined by the student's age and scores on earlier subtests. Spelling is the sixth subtest. Its starting point is also determined by earlier subtests. The final subtest is reading comprehension also called silent reading. The starting point is determined by the performance of the student on word recognition and word meaning. On any subtest, student performance is measured as they progress through items. If test items are determined to be too difficult or too easy jumps to easier or more difficult items may be triggered. Also in some cases the last two subtests of spelling and silent reading may be skipped if the student is not able to read independently. This is determined by subtests one to three.

One embodiment of the assessment system examines seven sub-skills of reading that together will paint an accurate picture of the learners' abilities. Different patterns of high and low sub-test scores warrant specific learning approaches. In addition, an assessment report provides tangible instructional suggestions to begin the student's customized reading instruction.

FIGS. 3A-3F show an exemplary reading test and assessment system that includes a plurality of sub-tests. Turning now to FIG. 3A, an exemplary user interface for a High Frequency Words Sub-test is shown. This subtest examines the learner's recognition of a basic sight-word vocabulary. Sight words are everyday words that people see when reading, often called words of “most-frequent-occurrence.” Many of these words are phonetically irregular (words that cannot be sounded out) and must be memorized. High-frequency words like the, who, what and those make up an enormous percentage of the material for beginning readers. In this subtest, a learner will hear a word and then see four words of similar spelling. The learner will click on the correct word. This test extends through third-grade difficulty, allowing a measurement of fundamental high-frequency word recognition skills.

FIG. 3B shows an exemplary user interface for a Word Recognition Subtest. This subtest measures the learner's ability to recognize a variety of phonetically regular (able to be sounded out) and phonetically irregular (not able to be sounded out) words. This test consists of words from first-grade to twelfth-grade difficulty. These are words that readers become familiar with as they progress through school. This test is made up of words that may not occur as often as high-frequency words but which do appear on a regular basis. Words like tree and dog appear on lower-level lists while ones like different and special appear on higher-level lists. In this subtest, a learner will see a word and hear four others of similar sound. The learner will click on a graphic representing the correct reading of the word in the text.

FIG. 3C shows an exemplary user interface for a Word Analysis Subtest. This subtest is made up of questions evaluating the learner's ability to recognize parts of words and sound words out. The skills tested range from the most rudimentary (consonant sounds) to the most complex (pattern recognition of multi-syllabic words). This test examines reading strategies that align with first-through fourth-grade ability levels. Unlike the previous two tests, this test focuses on the details of sounding out a word. Nonsense words are often used to reduce the possibility that the learner may already have committed certain words to memory. This test will create a measurement of the learner's ability to sound out phonetically regular words. In this subtest, the learner will hear a word and then see four others of similar spelling. The learner will click on the correct word.

FIG. 3D shows an exemplary user interface for a Phonemic Awareness Subtest. This subtest is made up of questions that evaluate the learner's ability to manipulate sounds that are within words. The learner's response is to choose from a choice of 4 different audio choices. Thus this Subtest doesn't require reading skills of the learner. The learner hears a word and is given instructions via audio. Then the learner hears 4 audio choices played aloud that correspond to 4 icons. The learner clicks on the icon that represents the correct audio answer.

FIG. 3E shows an exemplary user interface for a Word Meaning Subtest. This subtest is designed to measure the learner's receptive oral vocabulary skills. Unlike expressive oral vocabulary (the ability to use words when speaking or writing), receptive oral vocabulary is the ability to understand words that are presented orally. In this test of receptive oral vocabulary, learners will be presented with four pictures, will hear a word spoken, and will then click on the picture that matches the word they heard. For example, the learners may see a picture of an elephant, a deer, a unicorn and a ram. At the same time as they hear the word tusk, they should click on the picture of the elephant. All the animals have some kind of horn, but the picture of the elephant best matches the target word. This test extends to a twelfth-grade level. It evaluates a skill that is indispensable to the learner's ability to comprehend and read contextually, as successful contextual reading requires an adequate vocabulary.

FIG. 3F shows an exemplary user interface for a Spelling Subtest. This subtest will assess the learner's spelling skills. Unlike some traditional spelling assessments, this subtest will not be multiple-choice. It will consist of words graded from levels one through twelve. Learners will type the letters on the web page and their mistakes will be tracked. This will give a measure of correct spellings as well as of phonetic and non-phonetic errors.

FIG. 3G shows an exemplary user interface for a Silent Reading Subtest. This subtest, made up of twelve graded passages with comprehension questions, will evaluate the learner's ability to respond to questions about a silently read story. Included are a variety of both factual and conceptual comprehension questions. For example, one question may ask, “Where did the boy sail the boat?” while the next one asks, “Why do you think the boy wanted to paint the boat red?” This test measures the learner's reading rate in addition to his or her understanding of the story.

Once the learner has completed the seven sections of the assessment, a report as exemplified in FIG. 3H becomes available for online viewing or printing by the master account holder or by any properly authorized subordinate account holder. The report provides either a quick summary view or a lengthy view with rich supporting information. In this example, a particular student's performance is displayed in each sub-skill. The graph shown in FIG. 3H relates each sub-skill to grade level. Sub-skills one year or more behind grade level are marked by a “priority arrow.” At a glance, in High-Frequency Words, Spelling and Silent Reading, the student is one or more years behind grade level. These skills constitute the priority areas on which to focus teaching remediation, as indicated by the arrows. In practice, no student is exactly the same as another. Furthermore, the pattern of high and low skills determine which type of instruction is appropriate for each student. A reader's skill and reading profile can vary across the entire spectrum of possibilities. This reflects the diverse nature of the reading process and demonstrates that mastering reading can be a complicated experience for any student. Thus, the Reading Assessment embodiment of FIG. 3H diagnostically examines seven fundamental reading subskills to provide a map for targeted reading instruction.

After completing an assessment, students can be automatically placed into four instructional courses that target the five skill areas identified by the National Reading Panel. Teachers can modify students' placement into the instructional courses in real-time. Teachers can simply and easily repeat, change, or turn off lessons. The five skills are phonemic awareness, phonics, fluency, vocabulary, and comprehension. In phonemic awareness: the system examines a student's phonemic awareness by assessing his or her ability to distinguish and identify sounds in spoken words. Students hear a series of real and nonsense words and are asked to select the correct printed word from among several distracters. Lessons that target this skill are available for student instruction based upon performance. In phonics, the system assesses a student's knowledge of letter patterns and the sounds they represent through a series of criterion-referenced word sets. Phonetic patterns assessed move from short vowel, long vowel, and consonant blends on to diphthongs, vowel diagraphs, and decodable, multi-syllabic words. Lessons that target this skill are available for student instruction based upon performance. In fluency, the system assesses a student's abilities in this key reading foundation area. The capacity to read text fluently is largely a function of the reader's ability to automatically identify familiar words and successfully decode less familiar words. Lessons that target this skill are available for student instruction based upon performance. In vocabulary, the system assesses a student's oral vocabulary, a foundation skill critical to reading comprehension. Lessons that target this skill are available for student instruction based upon performance.

In other embodiments, the system assesses a student's ability to make meaning of short passages of text. Additional diagnostic data is gathered by examining the nature of errors students make when answering questions (e.g. the ratio of factual to inferential questions correctly answered). Lessons that target this skill are available for student instruction based upon performance.

High-quality PDF reports can be e-mailed or printed and delivered to parents. FIG. 3Ia shows an exemplary summary reading report of the DORA assessment. FIG. 3Ib shows an exemplary summary ADAM report. These reports inform the parents of their children's individual performance as well as guide instruction in the home setting. The reports generated by the system assists schools in intervening before a child's lack of literacy and/or math skills causes irreparable damage to the child's ability to succeed in school and in life. Classroom teachers are supported by providing them with individualized information on each of their students and ways they can meet the needs of these individual students. Teachers can sort and manipulate the assessment information on their students in multiple ways. For example, they can view the whole classroom's assessment information on a single page or view detailed diagnostic information for each student.

The reading assessment program shows seven core reading sub-skills in a table that will facilitate the instructor's student grouping decisions. The online instruction option allows teachers to supplement their existing reading curriculum with individualized online reading instruction when they want to work with the classroom as a group but also want to provide one-on-one support to certain individual students. Once a student completes the assessment, the system determines the course his or her supplemental reading instruction might most productively take.

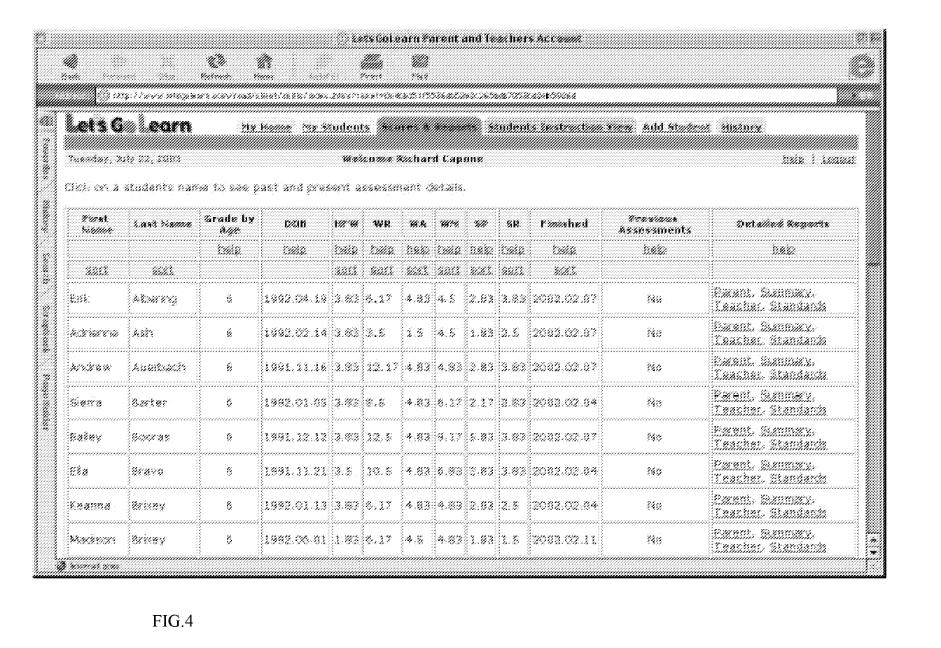

FIG. 4 shows a table view seen by teachers or specialists who log in. Their list of students can be sorted by individual reading sub-skills. This allows for easy sorting for effective small-group instruction and saves valuable class time. Students begin with instruction that is appropriate to their particular reading profiles as suggested by the online assessment. Depending on their profiles, students may be given all lessons across the four direct instructional courses, they may be placed into the one to three courses in which they need supplemental reading instruction, or they may be placed into other third-party instructional courses or programs which generally target students with specific profile needs.

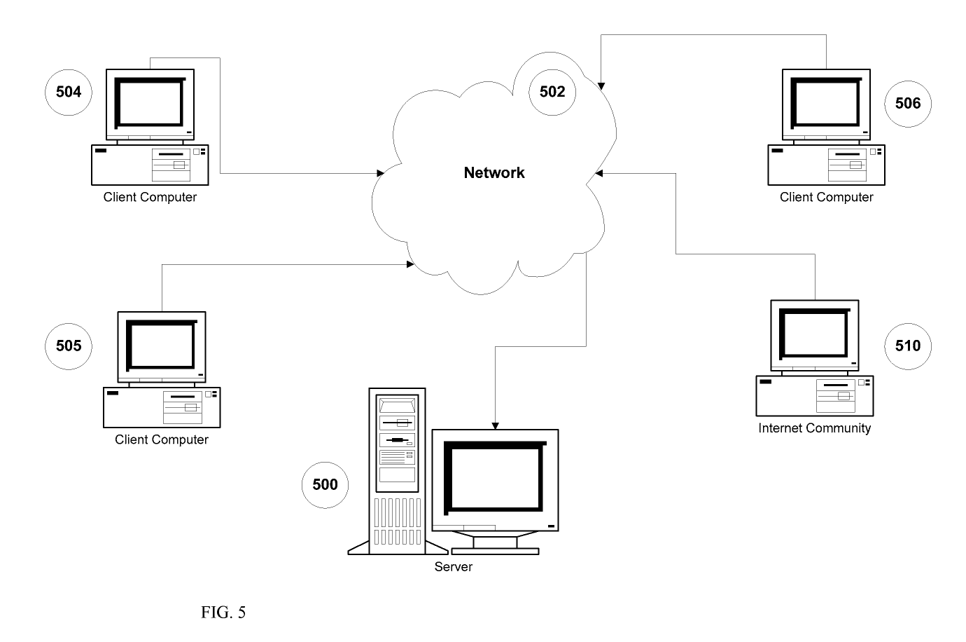

FIG. 5 shows an exemplary on-line system for adaptive diagnostic assessment. A server 500 is connected to a network 502 such as the Internet. One or more client workstations 504-506 are also connected to the network 502. The client workstations 504-506 can be personal computers, touchscreen devices such as the Apple iPads/Android OS devices, or workstations running browsers such as Mozilla, Chrome, Safari, or Internet Explorer. With the browser, a client or user can access the server 500's Web site by clicking in the browser's Address box, and typing the address (for example, www.vilas.com), then press Enter. When the page has finished loading, the status bar at the bottom of the window is updated. The browser also provides various buttons that allow the client or user to traverse the Internet or to perform other browsing functions.

An Internet community 510 with one or more educational companies, service providers, manufacturers, or marketers is connected to the network 502 and can communicate directly with users of the client workstations 504-506 or indirectly through the server 500. The Internet community 510 provides the client workstations 504-506 with access to a network of educational specialists.

Although the server 500 can be an individual server, the server 500 can also be a cluster of redundant servers. Such a cluster can provide automatic data failover, protecting against both hardware and software faults. In this environment, a plurality of servers provides resources independent of each other until one of the servers fails. Each server can continuously monitor other servers. When one of the servers is unable to respond, the failover process begins. The surviving server acquires the shared drives and volumes of the failed server and mounts the volumes contained on the shared drives. Applications that use the shared drives can also be started on the surviving server after the failover. As soon as the failed server is booted up and the communication between servers indicates that the server is ready to own its shared drives, the servers automatically start the recovery process. Additionally, a server farm can be used. Network requests and server load conditions can be tracked in real time by the server farm controller, and the request can be distributed across the farm of servers to optimize responsiveness and system capacity. When necessary, the farm can automatically and transparently place additional server capacity in service as traffic load increases.

The server 500 supports an educational portal that provides a single point of integration, access, and navigation through the multiple enterprise systems and information sources facing knowledge users operating the client workstations 504-506. The portal can additionally support services that are transaction driven. One such service is advertising: each time the user accesses the portal, the client workstation 504 or 506 downloads information from the server 500. The information can contain commercial messages/links or can contain downloadable software. Based on data collected on users, advertisers may selectively broadcast messages to users. Messages can be sent through banner advertisements, which are images displayed in a window of the portal. A user can click on the image and be routed to an advertiser's Web-site. Advertisers pay for the number of advertisements displayed, the number of times users click on advertisements, or based on other criteria. Alternatively, the portal supports sponsorship programs, which involve providing an advertiser the right to be displayed on the face of the port or on a drop down menu for a specified period of time, usually one year or less. The portal also supports performance-based arrangements whose payments are dependent on the success of an advertising campaign, which may be measured by the number of times users visit a Web-site, purchase products or register for services. The portal can refer users to advertisers' Web-sites when they log on to the portal. Additionally, the portal offers contents and forums providing focused articles, valuable insights, questions and answers, and value-added information about related educational issues.

The server enables the student to be educated with both school and home supervision. The process begins with the reader's current skills, strategies, and knowledge and then builds from these to develop more sophisticated skills, strategies, and knowledge across the five critical areas such as areas identified by the No Child Left Behind legislation. The system helps parents by bridging the gap between the classroom and the home. The system produces a version of the reading assessment report that the teacher can share with parents. This report explains to parents in a straightforward manner the nature of their children's reading abilities. It also provides instructional suggestions that parents can use at home.

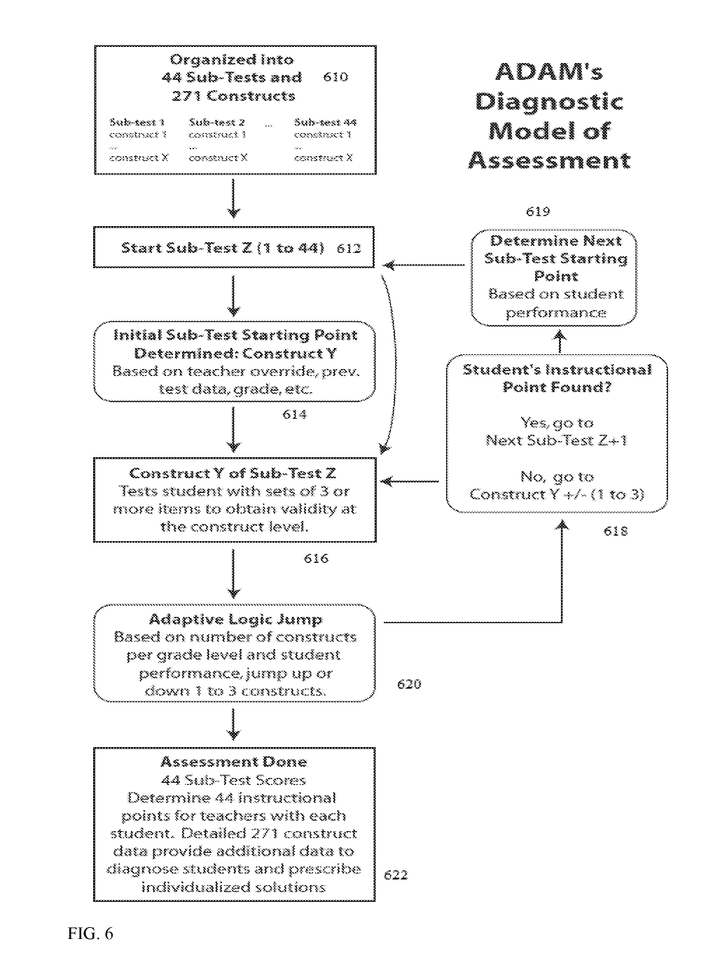

FIG. 6 shows one embodiment known as ADAM where the assessment is based on the same Let's Go Learn assessment engine (OAASIS) which provides diagnostic/formative assessment of students online. In this embodiment, tests are organized into 44 sub-tests and 271 constructs (610). The process starts sub-tests (612). An initial sub-test starting point is selected based on teacher preference, prior test results and grade, among others (614). Next, the process constructs a number of sub-tests such as testing students with sets of 3 or more items to obtain validity at a construct level (616). The system then performs an adaptive logic jump based on the number of constructs per grade level and student performance, among others, and moves up or down a predetermined number of constructs (620). The system then determines if the student's instruction point has been found (618). If not, the system varies the construct by a predetermined number of points and moves to 616. Alternatively, if the instruction point is found, the system determines the next sub-test starting point based on student performance (619) and loops back to 612. Once finished, the system determines the instructional points for teachers on each student. A detailed construction data is provided to help diagnose students and prescribe individual solutions.

Unlike all other assessments, ADAM assesses students online and in a manner that provides a thorough prescriptive diagnosis rather than simply reporting how students are performing against state standards or the national common core standards. Today, there are many assessments that advertise that they are diagnostic but if they are built on these state and common core standards they cannot truly be diagnostic because these standards are summative in nature, meaning they represent performance objectives by student grade levels. In other words, they define what each state and now the nation expect students to be able to do at each grade level. Diagnostic assessments like ADAM go beyond these standards and find out what foundation skills need to be taken in order to bring students up to grade level. For instance, sometimes students many not be able to do probability math problems at their grade level because they don't have the underlying foundation skill such as understanding fractions in order to do probability problem. In this case, a standards/summative based assessment would say that the student needs to be taught probability. ADAM however would uncover that the true problem is that the student lacks an understanding of fractions and then would identify where in the linear path of fractions instruction the student is at. What we are claiming is that ADAM is based on a pedagogy of mathematics that is not standards-based. This model is in essence a process that ADAM uniquely uses as it assesses students. Furthermore, the adaptive algorithms that ADAM uses are unique.

ADAM uniquely organizes and assesses students in mathematics by creating the following 44 sub-tests of mathematics and 271 math constructs. The 44-sub-tests break out into multiple constructs that are organized from easiest to hardest. This linear organization of the constructs corresponds to the way in which math is taught and thus uniquely aligns ADAM diagnosis directly to instruction. This alignment to an instructional model is unique since all other online assessments today are aligned to summative standards such as the common core and individual state instructional standards. The 44 sub-tests and 271 constructs in one embodiment are listed below:

| Sub-Test | Construct |
|---|---|
| Numbers | Numerals |
| | Counting Backwards |
| | Cardinal & Ordinal #'s |
| | Numerals (2 digit) |
| | Counting (by 1s 2s 3s 5s and 10s) |
| | Text and Numerals |
| | Counting (by hundreds and thousands) |
| | Comma & Place Holder |
| | Rounding |
| | Rounding (10s, 100s, 1,000s) |
| Place Value | Place Value |
| | Place Value |
| | Place Value (Thousand, Ten Thousand and Hundred Thousand) |
| | Place Value - Expanded Form |
| | Place Value (Thousand, Ten Thousand, Hundred Thousand, Millions) |
| | Place Value. Decimals. |
| Comparing and Ordering | Comparing (0-10) |
| | Comparing Using Symbols (2-digits) |
| | Comparing Using Symbols (3-digits) |
| | Money (equiv and non-equiv numbers using money) |
| | Comparing & Ordering |
| | Decimals (Comparing & Ordering) |
| Addition of Whole Numbers | Modeling addition and subtraction with objects |
| | Addition- Equivalent Forms |
| | Addition- (to 10) |
| | Addition (2-digit + 1-digit) |
| | Multi-digit Addition (non-regrouping) |
| | Addition (Regrouping) |
| | Addition (Multiple Digits) |
| Subtraction of Whole Numbers | Subtracting from 10 |
| | Multi-digit Subtraction (non-regrouping) |
| | Subtraction (Regrouping) |
| Multiplication of Whole Numbers | Multiplication Readiness (grouping and repeated addition) |
| | Multiplication Facts (Factors of 0 and 1) |
| | Multiplication Facts |
| | Multiplication (Powers of Ten) |
| | Multiplication (Commutative, Associative, Distributed) |
| | Multiplication (Two digit numbers by a single digit) |
| | Multiplication (Three digit numbers by a single digit numbers) |
| | Multiplication (Two and three digit numbers by a two digit) |
| | Multiplication (Commutative, Associative, Distributed) |
| Division of Whole Numbers | Modeling Division as the Inverse of Multiplication |
| | Division (Single diget divisor and Remainders) |
| | Division Facts |
| | Division (Whole Numbers) |
| | Division (four digits) |
| Fractions | Partitioning objects into parts |
| | Fractions (Representing fractions, comparing fractions, like denom or |
| | num) |
| | Fractions (as parts of sets |
| | Fraction (equivalent fractions) |
| | Fractions (Representing Fractions) |
| | Fractions (Equivalent fractions) |
| | Comparing (Fractions) |
| | Ordering Fractions |
| | Fractions (as decimals and place value tenth and hundredth) |
| | Fractions (solving problems) |
| | Fraction (equivalent fractions lowest terms) |
| | Fractions (as decimals and place value tenth and hundredth) |
| | Fractions (Comparing and Ordering) |
| | Fractions (least common multiple) |
| | Fractions (Adding like denominators) |
| | Multiplying Fractions by a whole number |
| | Fractions (proper, improper, and mixed Fractions) |
| | Fractions (Adding unlike denominators) |
| | Subtracting Fractions |
| | Fractions (multiplying patterns of fractions) |
| | Fractions (Multiplying & Dividing Fractions) |
| | Solving Problems Using Fractions |
| | Multiplying and Dividing Positive Fractions |
| | Least Common Multiple & Greatest Common Factor |
| | Converting Fractions |
| | Adding and Subtracting Fractions (unlike denominator) |
| Number Theory | Number Theory (Divisibility) |
| | Number Theory (Factors) |
| | Number Theory (Multiples) |
| | Number Theory (prime/composite numbers) |
| | Number Theory (Prime Factors) |
| | Number Theory (Common greatest factors) |
| | Number Theory (Divisibilty rules) |
| Decimal Operations | Decimals (Adding and Subtracting) |
| | Decimals (Multiplication & Money Notation) |
| | Decimals (Division) |
| | Terminating and Repeating Decimals |
| Percentages | Percentages (percents & fractions) |
| | Percentages (percents & decimals) |
| | Percentages (Ratios) |
| | Percentages (Proportions) |
| | Percentages (estimating and calculating) |
| | Calculate Percentages |
| | Percentage Increase and Decrease |
| | Discounts and Markups |
| Ratios and Proportions | Interpreting and Using Ratios |
| | Using Proportions to Solve Problems |
| Positive and Negative Integers | Positive and Negative Numbers |
| | Ordering Rational Numbers |
| | Solving Problems with Integer Operations |
| | Absolute Value |
| | Adding and Subtracting Negative Numbers |
| | Multiplying and Dividing Negative Numbers |
| Exponents | Scientific Notation |
| | Rational Integer Operations and Powers |
| | Irrational Numbers |
| | Negative Whole Number Exponents |
| | Square Roots |
| | Rational Numbers and Exponent Rules |
| Money | Money Recognition |
| | Money (Values) |
| Time | Time (Reading a clock) |
| | Time - Calendar (Months) |
| | Elapsed Time |
| | Time - Calendar (Weeks) |
| Temperature | Temperature - Concept |
| | Temperature - Reading Temp. |
| Length | Comparative Vocabulary |
| | Measuring Length by Object |
| | Number Line |
| | Customary & Metric - Concepts of Length |
| | Length. Customary and Metric Units |
| | Customary -- Length |
| | Customary -- Converting Units of Length |
| | Customary -- Comparing Units of Length |
| | Metric -- Length |
| | Metric -- Converting Units of Lengths |
| | Metric -- Comparing Metric Lengths |
| | Converting Units (More Complex) |
| Weight | Customary and Metric - Concepts of Weight |
| | Weight -- customary |
| | Weight -- Units of Measure |
| | Weight -- Converting and comparing units of weight |
| Capacity and Volume | Customary -- Capacity |
| | Metric -- Capacity |
| | Capcity -- Units of Measure |
| | Customary -- Units of Capacity/volume |
| | Metric -- Comparing Metric Capacity/Volume |
| Rate | Understanding Rate |
| | Solving Problems Using Rate |
| | Comparing Rates |
| | Scale |
| | Solving Rate Problems |
| Patterns and Sorting | Simple Patterns |
| | Sorting by Common Attributes |
| | Extending Patterns |
| | Extending Linear Patterns |
| | Problem Solving (Linear Patterns) |
| Data Representation | Simple Data Representation |
| | Multiple Representations of the Same Data |
| | Features of Data Sets |
| | Problem Solving (Data Represenation) |
| Simple Probability | Likelihood |
| | Simple Probability |
| | Estimating Future Events |
| | Representing Probabilities |
| | Probability of Multiple Events |
| Outcomes | Recording Outcomes |
| | Representing Results |
| | Representing Outcomes |
| | Representing Possible Outcomes |
| Displaying Data | Interpreting Graphs |
| | Displaying Data |
| | Comparing Data (Fractions and Percents) |
| | Data Representation |
| | Scatterplots |
| Measures of Central Tendency | Mean, Median, and Mode |
| | Mean, Median, and Mode (computing) |
| | Computing Measures of Central Tendency |
| | Changing Central Tendency |
| | Outliers |
| | Use of Measures of Central Tendency |
| | Data Set Quartiles |
| Ordered Pairs | Identifying Ordered Pairs |
| | Writing Ordered Pairs |
| Samples | Samples |
| | Selecting Samples |
| | Sampling Errors |
| | Independent and Dependent Events |
| Location and Direction | Location Vocabulary |
| | Location & Direction |
| 2D Shapes | 2D Shapes (Shape Given) |
| | Comparing Shapes |
| | 2D Shapes (Name Given) |
| | Shapes -- Attributes |
| | Describing Shapes |
| | Forming Polygons |
| | Polygons |
| | Identifying Congruency Figures |
| | Symmetry |
| | Elements of Geometric Figures |
| | Translations and Reflections |
| | Solving Problems Involving Congruence |
| 3D Shapes | 3D Faces |
| | 3D Shapes |
| | Composing 3D Shapes |
| | Qualities of Three-Dimensional Figures |
| | Patterns for 3-Dimensional Figures |
| | 3D Geometric Elements |
| Triangles | Triangles -- Attributes |
| | Right Angle Knowledge |
| | Triangle Definitions |
| | Solving for Unknown Angles |
| | Pythagorean Theorem |
| Quadrilaterals | Quadrilaterals -- Attributes |
| | Quadrilateral Definitions |
| Area and Perimeter | Dividing Rectangles into Squares (precursor to area/perimeter) |
| | Area (square units shown) |
| | Area vs Perimeter (figures with the same area, different perimeters) |
| | Solving for Area vs Perimeter |
| | Area and Perimeter Word Problems |
| | Units of Measure (2D & 3D Shapes) |
| | Area of Triangles and Parallelograms |
| | Perimeter, Area, and Volume |
| | Area of Complex Figures |
| Lines | Plotting Points of a Linear Equation |
| | Horizontal Line Segment Length |
| | Vertical Line Segment Length |
| | Parallel and Perpendicular Lines |
| Circles | Qualities of a Circle |
| | Pi |
| | Calculating using Pi |
| | Angles and Angle Measurement |
| Angles | Sum of Angles |
| | Types of Angles |
| Volume and Surface Area | Surface Area |
| | Volume |
| | Volume of Triangular Prisms and Cylinders |
| | Surface Area and Volume of Complex Solids |
| Geometric Relationships | Using Variables in Geometric Equations |
| | Expressing Geometric Relationship |
| | Changes of Scale |
| Relationships | Sorting by Unlike Objects |
| | Relationships of Quantities |
| | Symbolic Unit Conversions |
| | Comm. & Assoc. Properties of Mult. |
| | Rules of Linear Patterns |
| | Equivalent Addition |
| | Equivalent Multiplication |
| Expressions and Problem Solving | Number Sentences (addition and subtraction) |
| | Symbols |
| | Number Sentences and Problems (add. & subtr.) |
| | Problem Solving (add. & subtr.) |
| | Problem Solving Using Data (add. & subtr.) |
| | Selecting Operations |
| | Mathematical Expressions using Parentheses |
| | Order of Operations (with Parentheses) |
| | Using Distributive Property |
| | Writing Algebraic Expressions |
| | Equivalent Expressions |
| | Applying Order of Operations |
| | Solving Problems Using Order of Operations |
| | Writing Expressions |
| | Using Order of Operations to Evaluate Expressions |
| | Simplifying Expressions |
| | Positive Whole Number Powers |
| | Multiplying and Dividing Monomials |
| Equations | Problem Solving with Equations/Inequalities |
| | Functional Relationships (Problem Solving) |
| | Concept of Variables |
| | Formulas |
| | Simple Equations |
| | Problem Solving and Data |
| | Solving by Substitution |
| | Solving Linear Functions |
| | Solving One-Step Linear Equations |
| | Solving One-Step Inequalities |
| | Algebraic Terminology |
| | Solving Two-Step Linear Equations |
| | Solving Multi-Step Rate Problems |
| Graphing Algebraic Relationships | Coordinate Plane |
| | Graphic Representations |
| | Graphing Functions |
| | Slope |
| | Plotting Set Ratios |

In one embodiment, ADAM uniquely assesses students to find the true instructional ability of each student. 44 Sub-tests are made up of 271 sets of math constructs. These constructs are organized linearly from easiest to hardest, as defined by instructional difficulty, and will span multiple grade levels. ADAM adapts up and down these linear sub-tests to find the instructional point of each student which is critical in diagnosing and prescribing how to help students. In other words, when examining each of the 44 sub-tests, ADAM continues until it knows exactly where instruction should begin within each. An example of the linear nature of each sub-test can be illustrated by the multiplication sub-test. It is made up of 9 constructs that start with “grouping and repeated addition,” then go onto “single digit multiplication” progress to “2 and 3 digit by 2 digit multiplication,” and finally end with “commutative, associative, distributed properties.” These constructs span grade levels 3 to 5.

In contrast, standards based assessments will take items at the same grade level across all sub-tests at once. Then at best they make quasi-diagnostic or summative conclusions such as this student is below grade level in “4^{th} grade fractions” or “4^{th} grade measurement” and is at the X percentile. Standards based assessments are summative in nature because they are making summary conclusions about students at a higher level which is usually less than 44 sub-tests and primarily focus on comparing groups of students to other groups within very generalized areas of mathematics. Thus, for example:

Standards Model of Assessment
Math constructs are organized by grade levels and into the 5 major math strands listed in each column heading
Students are given a sampling of single test questions/items in constructs within their grade level.
Summative results span entire test or within general math strands listed below.

| Grade | Numbers & Operations | Meaurement | Data Analysis | Geometry | Algebraic Thinking |
|---|---|---|---|---|---|
| K | Math Construct 1 Item | Math Construct 1 Item | Math Construct 1 Item | Math Construct 1 Item | Math Construct 1 Item |
| K | Math Construct 2 Item | Math Construct 2 Item | Math Construct 2 Item | Math Construct 2 Item | Math Construct 2 Item |
| K | Math Construct 3 Item | Math Construct 3 Item | Math Construct 3 Item | Math Construct 3 Item | Math Construct 3 Item |
| K | . . . | . . . | . . . | . . . | . . . |
| K | Math Construct X Item | Math Construct X Item | Math Construct X Item | Math Construct X Item | Math Construct X Item |
| 1 | Math Construct 1 Item | Math Construct 1 Item | Math Construct 1 Item | Math Construct 1 Item | Math Construct 1 Item |
| 1 | Math Construct 2 Item | Math Construct 2 Item | Math Construct 2 Item | Math Construct 2 Item | Math Construct 2 Item |
| 1 | Math Construct 3 Item | Math Construct 3 Item | Math Construct 3 Item | Math Construct 3 Item | Math Construct 3 Item |
| 1 | . . . | . . . | . . . | . . . | . . . |
| 1 | Math Construct X Item | Math Construct X Item | Math Construct X Item | Math Construct X Item | Math Construct X Item |
| 2 | Math Construct 1 Item | Math Construct 1 Item | Math Construct 1 Item | Math Construct 1 Item | Math Construct 1 Item |
| 2 | Math Construct 2 Item | Math Construct 2 Item | Math Construct 2 Item | Math Construct 2 Item | Math Construct 2 Item |
| 2 | Math Construct 3 Item | Math Construct 3 Item | Math Construct 3 Item | Math Construct 3 Item | Math Construct 3 Item |
| 2 | . . . | . . . | . . . | . . . | . . . |
| 2 | Math Construct X Item | Math Construct X Item | Math Construct X Item | Math Construct X Item | Math Construct X Item |
| . . . | . . . | . . . | . . . | . . . | . . . |

In another embodiment, ADAM makes decisions about mastery of constructs (multiple constructs make up a sub-test) by grouping 3 or more actual test questions together. Uncovering actual individual student-performance on these sets of items determines mastery or non-mastery at ADAM's 271 construct level. Rather than report student diagnosis based on individual test questions that have statistical values derived from group testing, ADAM determines what each student can or cannot do at the construct level which is a set of items. This is unique to ADAM and critical in a diagnostic assessment because individual student diagnostic assessments like ADAM must reliably report on mastery at this very granular construct level for each student. See the figure below.

ADAM's Model of Assessment
Math constructs are organized by Sub-Tests
Students are tested based on their performance and ability regardless of the grade level
of the test questions

| Grade | Sub-Test 1 | Sub-Test 2 | Sub-Test 3 | . . . | Sub-Test 44 |
|---|---|---|---|---|---|
| K | Math Construct 1 Set | Math Construct 1 Set | Math Construct 1 Set | . . . | Math Construct 1 Set |
| K | Math Construct 2 Set | Math Construct 2 Set | Math Construct 2 Set | . . . | Math Construct 2 Set |
| K | Math Construct 3 Set | Math Construct 3 Set | Math Construct 3 Set | . . . | Math Construct 3 Set |
| K | . . . | . . . | . . . | . . . | . . . |
| K | Math Construct X Set | Math Construct X Set | Math Construct X Set | . . . | Math Construct X Set |
| 1 | Math Construct 1 Set | Math Construct 1 Set | Math Construct 1 Set | . . . | Math Construct 1 Set |
| 1 | Math Construct 2 Set | Math Construct 2 Set | Math Construct 2 Set | . . . | Math Construct 2 Set |
| 1 | Math Construct 3 Set | Math Construct 3 Set | Math Construct 3 Set | . . . | Math Construct 3 Set |
| 1 | . . . | . . . | . . . | . . . | . . . |
| 1 | Math Construct X Set | Math Construct X Set | Math Construct X Set | . . . | Math Construct X Set |
| 2 | Math Construct 1 Set | Math Construct 1 Set | Math Construct 1 Set | . . . | Math Construct 1 Set |
| 2 | Math Construct 2 Set | Math Construct 2 Set | Math Construct 2 Set | . . . | Math Construct 2 Set |
| 2 | Math Construct 3 Set | Math Construct 3 Set | Math Construct 3 Set | . . . | Math Construct 3 Set |
| 2 | . . . | . . . | . . . | . . . | . . . |
| 2 | Math Construct X Set | Math Construct X Set | Math Construct X Set | . . . | Math Construct X Set |
| . . . | . . . | . . . | . . . | . . . | . . . |
| 7 | Math Construct 1 Set | Math Construct 1 Set | Math Construct 1 Set | . . . | Math Construct 1 Set |
| 7 | Math Construct 2 Set | Math Construct 2 Set | Math Construct 2 Set | . . . | Math Construct 2 Set |
| 7 | Math Construct 3 Set | Math Construct 3 Set | Math Construct 3 Set | . . . | Math Construct 3 Set |
| 7 | . . . | . . . | . . . | . . . | . . . |
| 7 | Math Construct X Set | Math Construct X Set | Math Construct X Set | . . . | Math Construct X Set |

In comparison, standards-based assessments make conclusions based on large samples of data to predict student outcome. This is fine for group reports or when making generalizations about a student but for individual prescriptive student diagnosis, one must assume the student is not the norm. Often students who are not at grade level are not the norm, thus making conclusions that compare these students to the norm is intrinsically faulty. Standards based assessments will say that 80% of kids who miss construct A do not get construct B. So they don't bother to test construct B. But diagnostic assessments cannot be based on statistical assumptions because they are trying to find out “why” a particular student may be struggling and the reason often has to do with the student being unique.

In yet another embodiment, ADAM's adaptive logic uniquely follows the following formulas for adjusting up and down within a sub-test and for early termination of a set of test items within a construct:
Mastery of a construct is determined by a score of 66% correct or higher as a student is given the items in that construct. If mastery cannot be attained after a few questions, the construct is marked as non-mastered and ADAM moves on. This adaptive logic reduces the number of test items given to a student and thus reduces test-fatigue. Furthermore, if mastery is determined before all items in the set are given, the set will be stopped early, the construct marked as mastered, and ADAM will move on.
Jump sizes are how many constructs up or down the assessment will go after a construct is determined to be mastered or non-mastered. This jump size is uniquely determined by the number of constructs defined at a grade level in any particular sub-test.
In any particular sub-test:
   if total number of constructs are 1 or 2 at any single grade level jump size is +1 or −1.
   if total number of constructs are 3 or 4 at any single grade level jump size is +2 or −2.
   if total number of constructs are 5 or greater at any single grade level, jump size is +3 or −3.
   Reduce jump up or down if it will overjump a failed construct.
   Reduce jump down if it will overjump a mastered construct.
   Reduce jump down if it will exceed the lowest or highest construction in a sub-test

In yet another embodiment, ADAM attempts to reduce the chance that students will guess at a question and get it correct by virtue of the question being multiple-choice by adding an addition choice that turns on when a construct and its set of test items are above the student's grade level. Under these conditions, ADAM uniquely turns on a 5^{th} choice labeled as “I don't know.” If the student is given test items that are at his or her grade level or lower, this choice will not turn on.

In another embodiment, ADAM uniquely changes the test interface that a student is given by changing the interface of the test based on a student's grade level. The actual test items which include, the question, multiple answer choices, and audio files are not changed. This separation of the interface from the actual test items in online assessment increases engagement of the student being assessed and thus increases test reliability.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method to provide diagnostic assessment of reading or math performance for a student, comprising:
a. presenting a new concept to the student through a multimedia presentation;
b. testing the student on the concept at a predetermined testing level;
c. collecting test results and adapting testing items and sets of items based on student responses;
d. performing a formative diagnosis based on the students performance across multiple concepts to provide information to guide individualized instruction; and
e. adaptively modifying the predetermined testing level based on the organization of test items into diagnostic sub-tests and linear instructional constructs within each sub-test and then repeating (a)-(d) at the adaptively modified predetermined testing level for a plurality of sub-tests, wherein the sub-test has a number of constructs as follows:
For READING

| Sub-Test | Construct |
|---|---|
| High-Frequency Words | Leveled sight words (level 1 to 3) |
| Word Recognition | Leveled words (level 1 to 12) |
| Phonics | Some Beginning Sounds |
| | Most Beginning Sounds |
| | Short Vowel Sounds |
| | Consonant Blends |
| | Long Vowel Sounds |
| | Consonant Digraphs |
| | Vowel Digraphs |
| | R-Controlled Vowels |
| | Diphthongs |
| | Multi-Syllable |
| Phonemic Awareness | 9 tasks of phonemic awareness |
| Oral Vocabulary (Word Meaning) | Leveled words (level 1 to 12) |
| Comprehension (Silent Reading) | Leveled passages (Flesch-Kincaid |
| | levels 1 to 12) |

For MATH

| Sub-Test | Construct |
|---|---|
| Numbers | Numerals |
| | Counting Backwards |
| | Cardinal & Ordinal #'s |
| | Numerals (2 digit) |
| | Counting (by 1s 2s 3s 5s and 10s) |
| | Text and Numerals |
| | Counting (by hundreds and thousands) |
| | Comma & Place Holder |
| | Rounding |
| | Rounding (10s, 100s, 1,000s) |
| Place Value | Place Value |
| | Place Value |
| | Place Value (Thousand, Ten Thousand and Hundred Thousand) |
| | Place Value - Expanded Form |
| | Place Value (Thousand, Ten Thousand, Hundred Thousand, Millions) |
| | Place Value. Decimals. |
| Comparing and Ordering | Comparing (0-10) |
| | Comparing Using Symbols (2-digits) |
| | Comparing Using Symbols (3-digits) |
| | Money (equiv and non-equiv numbers using money) |
| | Comparing & Ordering |
| | Decimals (Comparing & Ordering) |
| Addition of Whole Numbers | Modeling addition and subtraction with objects |
| | Addition- Equivalent Forms |
| | Addition- (to 10) |
| | Addition (2-digit + 1-digit) |
| | Multi-digit Addition (non-regrouping) |
| | Addition (Regrouping) |
| | Addition (Multiple Digits) |
| Subtraction of Whole Numbers | Subtracting from 10 |
| | Multi-digit Subtraction (non-regrouping) |
| | Subtraction (Regrouping) |
| Multiplication of Whole Numbers | Multiplication Readiness (grouping and repeated addition) |
| | Multiplication Facts (Factors of 0 and 1) |
| | Multiplication Facts |
| | Multiplication (Powers of Ten) |
| | Multiplication (Commutative, Associative, Distributed) |
| | Multiplication (Two digit numbers by a single digit) |
| | Multiplication (Three digit numbers by a single digit numbers) |
| | Multiplication (Two and three digit numbers by a two digit) |
| | Multiplication (Commutative, Associative, Distributed) |
| Division of Whole Numbers | Modeling Division as the Inverse of Multiplication |
| | Division (Single diget divisor and Remainders) |
| | Division Facts |
| | Division (Whole Numbers) |
| | Division (four digits) |
| Fractions | Partitioning objects into parts |
| | Fractions (Representing fractions, comparing fractions, like denom or |
| | num) |
| | Fractions (as parts of sets |
| | Fraction (equivalent fractions) |
| | Fractions (Representing Fractions) |
| | Fractions (Equivalent fractions) |
| | Comparing (Fractions) |
| | Ordering Fractions |
| | Fractions (as decimals and place value tenth and hundredth) |
| | Fractions (solving problems) |
| | Fraction (equivalent fractions lowest terms) |
| | Fractions (as decimals and place value tenth and hundredth) |
| | Fractions (Comparing and Ordering) |
| | Fractions (least common multiple) |
| | Fractions (Adding like denominators) |
| | Multiplying Fractions by a whole number |
| | Fractions (proper, improper, and mixed Fractions) |
| | Fractions (Adding unlike denominators) |
| | Subtracting Fractions |
| | Fractions (multiplying patterns of fractions) |
| | Fractions (Multiplying & Dividing Fractions) |
| | Solving Problems Using Fractions |
| | Multiplying and Dividing Positive Fractions |
| | Least Common Multiple & Greatest Common Factor |
| | Converting Fractions |
| | Adding and Subtracting Fractions (unlike denominator) |
| Number Theory | Number Theory (Divisibility) |
| | Number Theory (Factors) |
| | Number Theory (Multiples) |
| | Number Theory (prime/composite numbers) |
| | Number Theory (Prime Factors) |
| | Number Theory (Common greatest factors) |
| | Number Theory (Divisibilty rules) |
| Decimal Operations | Decimals (Adding and Subtracting) |
| | Decimals (Multiplication & Money Notation) |
| | Decimals (Division) |
| | Terminating and Repeating Decimals |
| Percentages | Percentages (percents & fractions) |
| | Percentages (percents & decimals) |
| | Percentages (Ratios) |
| | Percentages (Proportions) |
| | Percentages (estimating and calculating) |
| | Calculate Percentages |
| | Percentage Increase and Decrease |
| | Discounts and Markups |
| Ratios and Proportions | Interpreting and Using Ratios |
| | Using Proportions to Solve Problems |
| Positive and Negative Integers | Positive and Negative Numbers |
| | Ordering Rational Numbers |
| | Solving Problems with Integer Operations |
| | Absolute Value |
| | Adding and Subtracting Negative Numbers |
| | Multiplying and Dividing Negative Numbers |
| Exponents | Scientific Notation |
| | Rational Integer Operations and Powers |
| | Irrational Numbers |
| | Negative Whole Number Exponents |
| | Square Roots |
| | Rational Numbers and Exponent Rules |
| Money | Money Recognition |
| | Money (Values) |
| Time | Time (Reading a clock) |
| | Time - Calendar (Months) |
| | Elapsed Time |
| | Time - Calendar (Weeks) |
| Temperature | Temperature - Concept |
| | Temperature - Reading Temp. |
| Length | Comparative Vocabulary |
| | Measuring Length by Object |
| | Number Line |
| | Customary & Metric - Concepts of Length |
| | Length. Customary and Metric Units |
| | Customary -- Length |
| | Customary -- Converting Units of Length |
| | Customary -- Comparing Units of Length |
| | Metric -- Length |
| | Metric -- Converting Units of Lengths |
| | Metric -- Comparing Metric Lengths |
| | Converting Units (More Complex) |
| Weight | Customary and Metric - Concepts of Weight |
| | Weight -- customary |
| | Weight -- Units of Measure |
| | Weight -- Converting and comparing units of weight |
| Capacity and Volume | Customary -- Capacity |
| | Metric -- Capacity |
| | Capcity -- Units of Measure |
| | Customary -- Units of Capacity/volume |
| | Metric -- Comparing Metric Capacity/Volume |
| Rate | Understanding Rate |
| | Solving Problems Using Rate |
| | Comparing Rates |
| | Scale |
| | Solving Rate Problems |
| Patterns and Sorting | Simple Patterns |
| | Sorting by Common Attributes |
| | Extending Patterns |
| | Extending Linear Patterns |
| | Problem Solving (Linear Patterns) |
| Data Representation | Simple Data Representation |
| | Multiple Representations of the Same Data |
| | Features of Data Sets |
| | Problem Solving (Data Represenation) |
| Simple Probability | Likelihood |
| | Simple Probability |
| | Estimating Future Events |
| | Representing Probabilities |
| | Probability of Multiple Events |
| Outcomes | Recording Outcomes |
| | Representing Results |
| | Representing Outcomes |
| | Representing Possible Outcomes |
| Displaying Data | Interpreting Graphs |
| | Displaying Data |
| | Comparing Data (Fractions and Percents) |
| | Data Representation |
| | Scatterplots |
| Measures of Central Tendency | Mean, Median, and Mode |
| | Mean, Median, and Mode (computing) |
| | Computing Measures of Central Tendency |
| | Changing Central Tendency |
| | Outliers |
| | Use of Measures of Central Tendency |
| | Data Set Quartiles |
| Ordered Pairs | Identifying Ordered Pairs |
| | Writing Ordered Pairs |
| Samples | Samples |
| | Selecting Samples |
| | Sampling Errors |
| | Independent and Dependent Events |
| Location and Direction | Location Vocabulary |
| | Location & Direction |
| 2D Shapes | 2D Shapes (Shape Given) |
| | Comparing Shapes |
| | 2D Shapes (Name Given) |
| | Shapes -- Attributes |
| | Describing Shapes |
| | Forming Polygons |
| | Polygons |
| | Identifying Congruency Figures |
| | Symmetry |
| | Elements of Geometric Figures |
| | Translations and Reflections |
| | Solving Problems Involving Congruence |
| 3D Shapes | 3D Faces |
| | 3D Shapes |
| | Composing 3D Shapes |
| | Qualities of Three-Dimensional Figures |
| | Patterns for 3-Dimensional Figures |
| | 3D Geometric Elements |
| Triangles | Triangles -- Attributes |
| | Right Angle Knowledge |
| | Triangle Definitions |
| | Solving for Unknown Angles |
| | Pythagorean Theorem |
| Quadrilaterals | Quadrilaterals -- Attributes |
| | Quadrilateral Definitions |
| Area and Perimeter | Dividing Rectangles into Squares (precursor to area/perimeter) |
| | Area (square units shown) |
| | Area vs Perimeter (figures with the same area, different perimeters) |
| | Solving for Area vs Perimeter |
| | Area and Perimeter Word Problems |
| | Units of Measure (2D & 3D Shapes) |
| | Area of Triangles and Parallelograms |
| | Perimeter, Area, and Volume |
| | Area of Complex Figures |
| Lines | Plotting Points of a Linear Equation |
| | Horizontal Line Segment Length |
| | Vertical Line Segment Length |
| | Parallel and Perpendicular Lines |
| Circles | Qualities of a Circle |
| | Pi |
| | Calculating using Pi |
| | Angles and Angle Measurement |
| Angles | Sum of Angles |
| | Types of Angles |
| Volume and Surface Area | Surface Area |
| | Volume |
| | Volume of Triangular Prisms and Cylinders |
| | Surface Area and Volume of Complex Solids |
| Geometric Relationships | Using Variables in Geometric Equations |
| | Expressing Geometric Relationship |
| | Changes of Scale |
| Relationships | Sorting by Unlike Objects |
| | Relationships of Quantities |
| | Symbolic Unit Conversions |
| | Comm. & Assoc. Properties of Mult. |
| | Rules of Linear Patterns |
| | Equivalent Addition |
| | Equivalent Multiplication |
| Expressions and Problem Solving | Number Sentences (addition and subtraction) |
| | Symbols |
| | Number Sentences and Problems (add. & subtr.) |
| | Problem Solving (add. & subtr.) |
| | Problem Solving Using Data (add. & subtr.) |
| | Selecting Operations |
| | Mathematical Expressions using Parentheses |
| | Order of Operations (with Parentheses) |
| | Using Distributive Property |
| | Writing Algebraic Expressions |
| | Equivalent Expressions |
| | Applying Order of Operations |
| | Solving Problems Using Order of Operations |
| | Writing Expressions |
| | Using Order of Operations to Evaluate Expressions |
| | Simplifying Expressions |
| | Positive Whole Number Powers |
| | Multiplying and Dividing Monomials |
| Equations | Problem Solving with Equations/Inequalities |
| | Functional Relationships (Problem Solving) |
| | Concept of Variables |
| | Formulas |
| | Simple Equations |
| | Problem Solving and Data |
| | Solving by Substitution |
| | Solving Linear Functions |
| | Solving One-Step Linear Equations |
| | Solving One-Step Inequalities |
| | Algebraic Terminology |
| | Solving Two-Step Linear Equations |
| | Solving Multi-Step Rate Problems |
| Graphing Algebraic Relationships | Coordinate Plane |
| | Graphic Representations |
| | Graphing Functions |
| | Slope |
| | Plotting Set Ratios. |

2. The method of claim 1, comprising sub-testing the student across high-frequency words (sight words), word recognition, word analysis (phonics), word meaning (oral vocabulary), spelling, reading comprehension and optionally sub-testing the student in phonemic awareness.

3. The method of claim 1, comprising testing high frequency words by determining recognition of a basic sight-word vocabulary presented to the test-taker in leveled sets of words in order to provide diagnostic validity in high-frequency word.

4. The method of claim 3, wherein the student is presented with a word sound and wherein the student selects an answer from a plurality of text choices organized into leveled sets of words.

5. The method of claim 1, wherein the student's response time is measured with a local computer clock and factored into a determination of each student's response to compensate for Internet latency variance.

6. The method of claim 1, comprising performing a word recognition sub-test by determining recognition of phonetically regular and phonetically irregular words presented to the test-taker in leveled sets of words in order to provide diagnostic validity in the word recognition sub-test

7. The method of claim 6, wherein the student is presented with a leveled set of word sound and selects an answer from a plurality of text choices for each word sound

8. The method of claim 1, comprising performing a word analysis (phonics) sub-test by determining mastery or non-mastery of specific phonetic principles by organized each phonetic principle into a set of 8 to 10 test questions and thus providing diagnostic validity at the phonetic principle level.

9. The method of claim 8, wherein the student is presented with a word sound and the student selects from a plurality of text answers composed of real and non-real text words choices and presented as sets of test items in order to provide diagnostic validity at the phonetic principle level.

10. The method of claim 8, comprising testing with real and non-real words to isolate student's knowledge of phonetic principles by removing high word recognition skill as a biased factor in tests with real words only.

11. The method of claim 1, comprising performing a phonemic awareness sub-test by determining recognition and manipulation of sounds within words played to students.

12. The method of claim 11, comprising rendering question and answer choices as streaming audio files to the student thereby eliminating the need for the student to be able to read and thus providing for the true diagnostic testing and isolation of phonemic awareness which would be rendered invalid if pictures or text were present in the test questions.

13. The method of claim 1, comprising performing a word meaning sub-test by determining a receptive oral vocabulary by presenting a word and then multiple picture choices all organized into sets of test questions in order to provide diagnostic validity in oral vocabulary.

14. A server to provide educational diagnostic assessment of reading or math performance for a student, comprising:
a network interface coupled to a wide area network; and
a processor coupled to the network interface and executing computer readable code to receive a log-in from the student over a network; present a new concept to the student through a multimedia presentation; test the student on the concept at a predetermined learning level; collect test results for one or more concepts into a test result group; perform a formative diagnostic analysis of the test result group; and adaptively modify the predetermined testing level based on the adaptive diagnostic analysis and repeating testing at the modified predetermined learning level for a plurality of sub-tests.

15. The server of claim 14, comprising
computer readable code to uniquely assesses students to find the true instructional ability of each student and wherein constructs are organized linearly from easiest to hardest, as defined by instructional difficulty, and span multiple grade levels; and
computer readable code to adapt the linear sub-tests to find an instructional point of each student for diagnosing and prescribing how to help students.

16. The server of claim 14, comprising code to determine mastery of constructs with multiple constructs forming a sub-test by grouping 3 or more test questions together and code to determine mastery or non-mastery at a predetermined construct level by analyzing individual student-performance.

17. The server of claim 14, wherein mastery of a construct is determined by a score of 66% correct or higher as a student is given the items in a predetermined construct and if mastery is not attained after a predetermined number of questions, the construct is marked as non-mastered.

18. The server of claim 14, comprising determining jump sizes for a construct after the construct is determined to be mastered or non-mastered, wherein the jump size is uniquely determined by the number of constructs defined at a grade level in any particular sub-test.

19. The server of claim 18, wherein for a particular sub-test:
a.—if total number of constructs are 1 or 2 at any single grade level jump size is +1 or −1.
b.—if total number of constructs are 3 or 4 at any single grade level jump size is +2 or −2.
c.—if total number of constructs are 5 or greater at any single grade level, jump size is +3 or −3.
d.—Reduce jump up or down if it will overjump a failed construct.
e.—Reduce jump down if it will overjump a mastered construct.
f.—Reduce jump down if it will exceed the lowest or highest construction in a sub-test.

20. The server of claim 14, comprising code to reduce student guessing at a multiple-choice question with an addition choice that turns on when a construct and its set of test items are above the student's grade level.

21. The server of claim 14, comprising code to uniquely change a test interface based on a student's grade level, wherein the separation of the test interface from actual test items increases engagement of the student being assessed and test reliability.
